(19) United States
(12) Patent Application Publication
(10) Pub. No.: US 2014/0135968 A1
(43) Pub. Date: May 15, 2014

(54) METHOD OF MAINTAINING A SEMICONDUCTOR PRODUCTION LINE

(71) Applicant: SAMSUNG ELECTRONICS CO., LTD., SUWON-SI (KR)

(72) Inventors: Ho-Ki LEE, Seongnam-si (KR); Heeseok KIM, Seongnam-si (KR); Sungho HAN, Seoul (KR)

(73) Assignee: SAMSUNG ELECTRONICS CO., LTD., SUWON-SI (KR)

(21) Appl. No.: 14/018,980

(22) Filed: Sep. 5, 2013

(30) Foreign Application Priority Data
Sep. 5, 2012 (KR) 10-2012-0098466

(51) Int. Cl. G05B 13/00

(52) U.S. Cl. CPC G05B 13/00
USPC 700/108

(57) ABSTRACT

In one example embodiment, a method of maintaining a semiconductor manufacturing line includes setting up a recipe for controlling an implementation of a unit process based on which at least one semiconductor device is manufactured by a manufacturing facility. The method further includes collecting reference data of the manufacturing facility being controlled according to the reference recipe and obtaining a statistical model of the reference data and a health index of the statistical model, the health index being a limit beyond which an output of the semiconductor manufacturing line decreases. The method further includes controlling the implementation of the unit process and obtaining monitoring data during the implementation of the unit process using the statistical mode. The method further includes renewing the statistical model based on the monitoring data.

### CROSS-REFERENCE TO RELATED APPLICATIONS

This U.S. non-provisional patent application claims priority under 35 U.S.C. §119 of Korean Patent Application No. 10-2012-0098466, filed on Sep. 5, 2012, the entire contents of which are hereby incorporated by reference.

### BACKGROUND

A critical dimension (CD) of a semiconductor device may be changed with the lapse of accumulated process time of semiconductor manufacturing facility. A preventive maintenance (PM) is performed on a semiconductor manufacturing facility over a period of a specific process accumulated time. The preventive maintenance (PM) can rapidly change an internal environment of the semiconductor manufacturing facility. Immediately after the preventive maintenance (PM), a seasoning process may be performed on the semiconductor manufacturing facility. The seasoning process can make an internal environment of the semiconductor manufacturing facility stable.

However, there was conventionally no way to check a stabilization time of the semiconductor manufacturing facility. Also, even after the seasoning process, a method of continually checking stability of the semiconductor manufacturing facility has not been suggested. Thus, it may be impossible to stably maintain the semiconductor manufacturing facility.

### SUMMARY

Some example embodiments provide methods for maintaining a semiconductor manufacturing line.

In one example embodiment, a method of maintaining a semiconductor manufacturing line includes setting up a recipe for controlling an implementation of a unit process based on which at least one semiconductor device is manufactured by a manufacturing facility. The method further includes collecting reference data of the manufacturing facility being controlled according to the reference recipe and obtaining a statistical model of the reference data and a health index of the statistical model, the health index being a limit beyond which an output of the semiconductor manufacturing line decreases. The method further includes controlling the implementation of the unit process and obtaining monitoring data during the implementation of the unit process using the statistical mode. The method further includes renewing the statistical model based on the monitoring data.

In yet another example embodiment, the statistical model is based on T² statistics.

In yet another example embodiment, the T² statistics are based on the monitoring data and a T² value is associated with a generalized distance between the reference data and the monitoring data.

In yet another example embodiment, the health index is a management limit line of the T² value.

In yet another example embodiment, the health index is a seasoning section line of the manufacturing facility.

In yet another example embodiment, the method further includes performing a seasoning process of the manufacturing facility, the seasoning process including coating a chamber of the manufacturing facility prior to the manufacturing facility initiating production of the at least one semiconductor device. The method further includes obtaining seasoning monitoring data of the seasoning process using the statistical model and a seasoning section line and judging whether the seasoning process of the manufacturing facility is completed based on the seasoning section line. The method further includes renewing the statistical model using the seasoning monitoring data as a seasoning reference data if the seasoning process is not completed and repeating the seasoning process.

In yet another example embodiment, when the T² value is below the seasoning section line, the seasoning process is completed.

In yet another example embodiment, the method further includes renewing the statistical model by using the seasoning monitoring data when the seasoning process is completed.

In yet another example embodiment, the method further includes generating an interlock control signal when the T² value exceeds from the management limit line. The method further includes communicating the interlock control signal to the manufacturing facility.

In yet another example embodiment, the management limit line is calculated from F distribution.

In one example embodiment a method of maintaining a semiconductor manufacturing line includes setting up a recipe for controlling an implementation of a unit process based on which at least one semiconductor device is manufactured by a manufacturing facility and collecting reference data of the manufacturing facility being controlled according to the reference recipe. The method further includes obtaining a statistical model for the reference data and a health index of the statistical model. The method further includes performing a seasoning process of the manufacturing facility and obtaining first monitoring data of the seasoning process using the statistical model. The method further includes judging whether the seasoning process of the manufacturing facility is completed based on the health index and renewing the modeling using the first monitoring data as the reference data when the seasoning process is completed. The method further includes controlling the implementation of the unit process, obtaining second monitoring data during the implementation of the unit process using the renewed statistical model, and further renewing the renewed statistical model using the second monitoring data as the reference data.

In yet another example embodiment, the method upon judging the seasoning process of the manufacturing facility is not complete, the renewing includes renewing the statistical model using the seasoning monitoring data as the reference data.

In yet another example embodiment, the health index is at least one of a seasoning section line value and a management limit line value being calculated based on the statistical model.

In yet another example embodiment, when a statistics value of the statistical model is below the seasoning section line value, the seasoning process is completed.

In yet another example embodiment, the method further includes generating an interlock control signal when a statistics value of the statistical model exceeds the management limit line value. The method further includes communicating the. interlock control signal to the manufacturing facility.

In one example embodiment, a method of maintaining a semiconductor production line includes controlling at least one manufacturing facility based on a unit process, the manufacturing facility manufacturing a plurality of semiconductor devices, the unit process being used in manufacturing the plurality of semiconductor devices. The method further includes determining a statistical model and an associated first threshold based on the controlling. The method further includes monitoring the at least one manufacturing facility as the at least one manufacturing facility manufactures the plurality of semiconductor devices according to the unit process and determining whether to terminate the unit process based on at least the monitoring, the statistical model and the associated first threshold.

In yet another example embodiment, the controlling includes selecting a manufacturing recipe for the unit process and obtaining reference data associated with the at least one manufacturing facility of the semiconductor production line.

In yet another example embodiment, the unit process is at least one of an etching process, a deposition process, a photo process, an ashing process and an ion implantation process and the reference data is at least one of monitoring data associated with a preceding unit process and data associated with a preventive maintenance period prior to manufacturing of the plurality of semiconductor devices according to the unit process.

In yet another example embodiment, the method further includes performing a seasoning process of the at least one manufacturing facility prior to the at least one manufacturing facility manufacturing the plurality of semiconductor devices according to the unit process, the seasoning process including coating a chamber of the at least one manufacturing facility prior to the manufacturing initiating the manufacturing.

In yet another example embodiment, the performing the seasoning process includes obtaining seasoning monitoring data of the seasoning process using the statistical model and an associated second threshold, determining whether the seasoning process of the manufacturing facility is completed based on the associated second threshold, and renewing the statistical model using the seasoning monitoring data as a seasoning reference data if the seasoning process is not completed.

In yet another example embodiment, the determining whether to terminate the unit process includes determining whether a distance between the monitored data and the reference data exceeds the associated first threshold, renewing the statistical model with the monitored data as a new reference data upon determining that the distance does not exceed the associated first threshold, and terminating the unit process upon determining that the distance exceeds the associated first threshold.

### BRIEF DESCRIPTION OF THE FIGURES

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 is a block diagram illustrating a semiconductor manufacturing system for performing a method of maintaining a semiconductor manufacturing line, according to an example embodiment.

FIG. 2 is a time flow chart illustrating a method for maintaining a semiconductor manufacturing, according to an example embodiment.

FIG. 3 is a graph illustrating a management limit line of T² statistics, according to an example embodiment.

FIG. 4 is a time flow chart illustrating a method for maintaining a semiconductor manufacturing line, according to an example embodiment.

FIG. 5 is a graph illustrating a seasoning section line of T² statistics, according to an example embodiment.

### DETAILED DESCRIPTION OF THE EMBODIMENTS

Example embodiments will be described more fully hereinafter with reference to the accompanying drawings, in which the example embodiments are shown. The inventive concept may, however, be embodied in many different forms and should not be construed as limited to the embodiments set forth herein. Rather, these embodiments are provided so that this disclosure will be thorough and complete, and will fully convey the concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

Spatially relatively terms, such as “beneath,” “below,” “above,” “upper,” “top,” “bottom” and the like, may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, when the device in the figures is turned over, elements described as below and/or beneath other elements or features would then be oriented (rotated 90 degrees or at other orientations) and the spatially relative descriptors used herein interpreted accordingly. As used herein, “height” refers to a direction that is generally orthogonal to the faces of a substrate.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

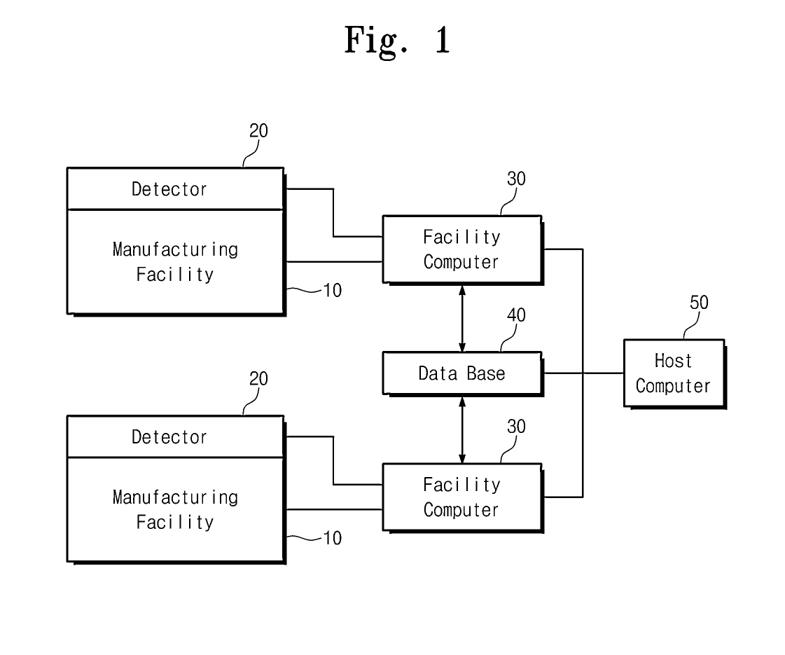

FIG. 1 is a block diagram illustrating a semiconductor manufacturing system for performing a method of maintaining a semiconductor manufacturing line, according to an example embodiment.

As illustrated in FIG. 1, the semiconductor manufacturing system may include one or more manufacturing facilities 10, one or more detectors 20, one or more facility computers 30, a data base 40 and a host computer 50. The manufacturing facility 10 is a unit process apparatus for manufacturing a semiconductor device. A unit process may be performed according to a recipe of the manufacturing facility 10. The manufacturing facility 10 may include an etching facility, a deposition facility, a photo facility, an ashing facility or an ion implantation facility. The manufacturing facility 10 may perform the corresponding unit process according to a process recipe. A preventive maintenance (PM) of the manufacturing facility 10 may be performed over a period of an accumulated use time of the unit process.

The detector 20 can generate monitoring data representing a state of the manufacturing facility 10. The monitoring data may be detected depending on a recipe of the manufacturing facility 10. The detector 20 may include an etching end point detector (EPD), an optical spectrometer, a VI probe, an electron microscope, an optical microscope, an X-ray inspection apparatus or an optical sensor.

The facility computer 30 can control the manufacturing facility 10. The facility computer 30 may generate a control signal for changing a process recipe of the manufacturing facility 10 from the monitoring data. The process recipe and the monitoring data may have a linear functional relation. The facility computer 30 may monitor a state of the manufacturing facility 10 in real time using the monitoring data being received through the detector 20. The data base 40 may store the monitoring data.

The host computer 50 may systematically manage the one or more manufacturing facilities 10 and the one or more of facility computers 20, each of which may be associated with one of the manufacturing facilities 10, in all areas of a semiconductor production line (not shown). The host computer 50 may record an entire unit process data being generated from the manufacturing facility 10 and the detector 20 and is set to be linked to a subsequent process. For instance, the facility computer 30 and the host computer 50 may communicate with each other and may share data with each other by a transmission protocol/internet protocol (TCP/IP) or a semi equipment communication standard (SECS) protocol via at least one wired/wireless communication link.

The facility computer 30 or the host computer 50 may control the manufacturing facility 10 using a statistical process control (SPC) method. The SPC method may include T² statistics defined by the following mathematical formula:

T²=(x− x̅)^{T}S⁻¹(x− x̅) (1)

The x is a measurement vector or monitoring data. The x̅ is an average vector or reference data. The S is covariance. The T² statistics may be calculated from a generalized distance of measurement vector (x) and average vector ( x̅). When the measurement vector (x) is constituted by a statistical process measured value of p dimension, the measurement vector (x) may be expressed by the following mathematical formula:

x^{T}=[x₁, x₂, . . . xₚ] (2)

The inverse measurement vector x^{T} may have horizontal and vertical elements. In one example embodiment, the statistical process measured value is obtained at n number of different times, the measurement vector (x) of mathematical formula 1 may be expressed as a matrix X of (n×p). Each row in the matrix X is a measurement vector (x) detected at a given time and each column is the entire measured value of corresponding variable and may be expressed by the following mathematical formula:

$$X = [ \begin{matrix}{x}_{11} & {x}_{12} & {x}_{13} & … & {x}_{1}^{T} \\ {x}_{21} & {x}_{22} & {x}_{23} & … & {x}_{2}^{T} \\ {x}_{31} & {x}_{32} & {x}_{33} & … & {x}_{3}^{T}\end{matrix} ] \qquad ( 3 )$$

Here, the inverse measurement vector x₁^{T}=[x₁, x₂, x₃, . . . , xₚ] while x̅₁^{T}=[ x̅₁, x̅₂, x̅₃, . . . , x̅ₚ]. x̅_{1J} is an average of jth column of matrix X of the mathematical formula (3). Thus, covariance S may be expressed by the following mathematical formula using the matrix X of the mathematical formula (3):

$$S = \frac{{\sum }_{i = 1}^{n} ( {x}_{1} - \overline{x} ) ( {x}_{i} - \overline{x} )}{n - 1} \qquad ( 4 )$$

Thus, T² statistics is a measure of a distance between the measurement vector (x) and the average vector x̅ in a p dimensional space. The T² statistics considers a correlation between variables x and x̅ using an inverse matrix of the covariance matrix as, for example, reflected in the mathematical formula (1). The distance considering a correlation between variables is called a statistical distance as distinguished from an Euclidean distance in a p dimensional space. For example, in case that p is 2, points having the same statistical distance from an average vector x^{T}=[x₁, x₂] have an elliptical shape considering a correlation between two variables x1 and x2 and all of the points on the ellipse have the same T² value. If measurement vector (x) and average vector x̅ or monitoring data and reference data are determined, the T² statistics may be calculated as the T² value. In one example embodiment where that process variables obey the normal distribution, the T² statistics may obey F distribution as reflected in the following mathematical formula 5:

$$\frac{n ( n - p )}{( {n}^{2} - 1 ) p} {T}^{2} \sim F ( p , n - p ) \qquad ( 5 )$$

Thus, a management limit line of T² statistics may be calculated by the following mathematical formula using the F distribution:

$${UCL}_{{T}^{2}} = \frac{( {n}^{2} - 1 ) p}{n ( n - p )} {F}_{a} ( p , n - p ) \qquad ( 6 )$$

Here, Fₐ(p, n−p) is (1-a) quantile of F distribution having the degree of freedom of p and (n−p).

Since T² statistics considers a correlation between process variables x and x̅, the T² statistics may be more sensitive to process fluctuation as compared to the case of independently managing each process variable using p number of univariate control charts. Thus, the facility computer 30 and the host computer 50 can control a manufacturing facility using a statistical process control method of T² statistics.

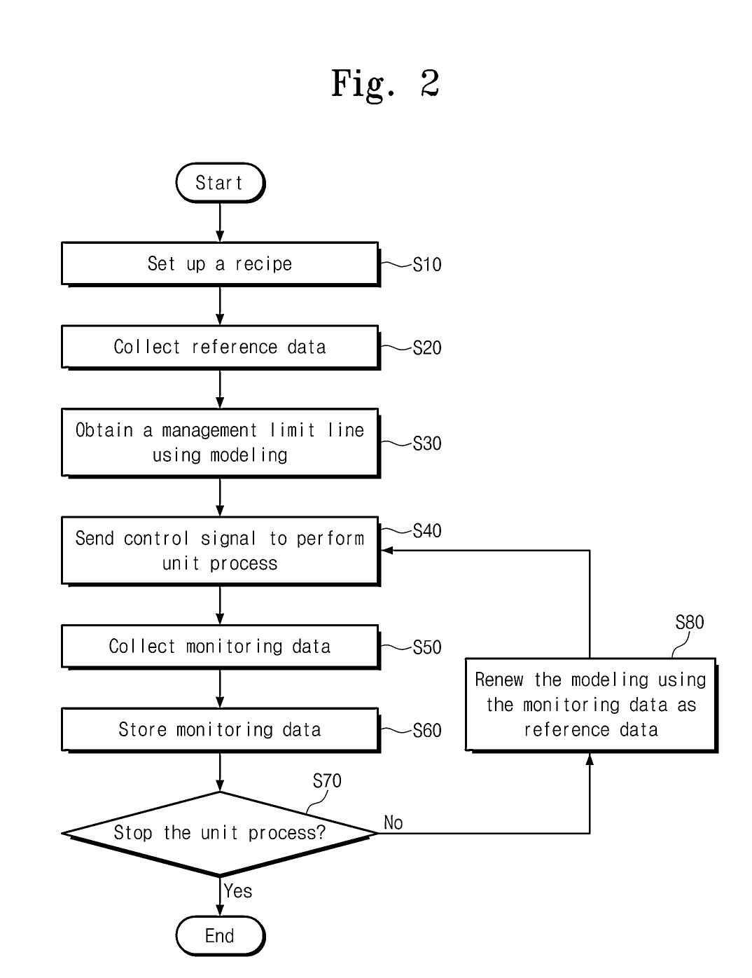

A management method of a semiconductor manufacturing line to which a statistical process control method is applied will be described as follows with reference to FIG. 2.

FIG. 2 is a time flow chart illustrating a method for maintaining a semiconductor manufacturing line, according to an example embodiment.

Referring to FIGS. 1 and 2, the facility computer 30 sets up a recipe of the manufacturing facility 10 for a corresponding unit process (S10). The standard recipe may include process variable values of the facility computer 10 in a unit process. The process variables may be changed according to any one of, but not limited to, time and order of the unit process.

Thereafter, facility computer 30 collects reference data of the manufacturing facility 10 from the detector 20 (S20). The reference data may be reference monitoring data being obtained from the manufacturing facility 10 set to be a reference recipe. In one example embodiment, the facility computer 30 may collect reference data over a preventive maintenance period of at least one time to store the collected reference data in the data base 40. For example, the facility computer 30 can monitor a state of the manufacturing facility 10 according to accumulated operating hours.

The facility computer 30 may obtain a modeling that statistically manages the manufacturing facility 10 based on the reference data and a health index of the modeling are drawn (S30). The modeling may include T² statistics, as described above. The health index may include a management limit line of the manufacturing facility 10.

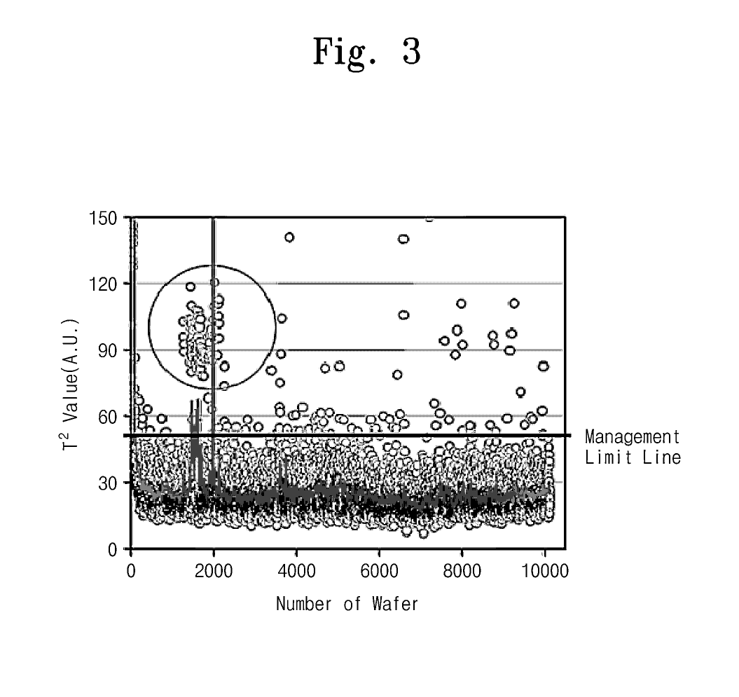

FIG. 3 is a graph representing a management limit line of T² statistics, according to an example embodiment. FIG. 3 illustrates a T² value and the management limit line is a T² value of about 50. In FIG. 3, a horizontal axis represents the number of wafers finishing a corresponding unit process. A vertical axis represents a T² value and has no unit. The management limit line is a statistical numerical value for a process of monitoring of the manufacturing facility 10. In one example embodiment, if a T² value exceeds the management limit line, the facility computer 30 may output an interlock control signal to the manufacturing facility 10, directing the manufacturing facility 10 to terminate the manufacturing of the semiconductor devices.

Referring back to FIGS. 1 and 2, the facility computer 30 sends a control signal to the manufacturing facility 10 to perform the unit process corresponding to the recipe selected at S10 (S40). The unit process may include processes for one substrate, one lot, a plurality of substrates or a plurality of lots. The facility computer 30 can monitor a state of the manufacturing facility 10 in real time using the modeling. The modeling may be calculated from monitoring data being detected through the detector 20 in the manufacturing facility 10 while in operation. The monitoring data may be managed as T² statistics according to a generalized distance from the reference data. The reference data may be monitoring data of a preceding process just before a corresponding unit process. The reference data may be an external input provided after a preventive maintenance of the manufacturing facility 10 and prior to the first unit process. Thereafter, the reference data may be monitoring data in a preceding unit process. The facility computer 30 collects monitoring data to store the monitoring data in the data base 40.

The facility computer 30 may collect monitoring data associated with unit process being performed/implemented by the manufacturing facility 10 (S50). The monitoring data may be T² statistics. If a T² value of T² statistics exceeds the management limit line, the facility computer 30 may output an interlock control signal to the manufacturing facility 10 directing the manufacturing facility 10 to terminate the manufacturing of the semiconductor devices. The facility computer 30 may further store the collected monitoring data in a database such as database 40 (S60).

Thereafter, the facility computer 30 determines whether the unit process is to be stopped (S70). In one example embodiment, when a preventive maintenance of the manufacturing facility 10 is performed, the facility computer 30 determines that the unit process is to stop. Thereafter, the process may end.

However, if the facility computer determines that the unit process is to be continued, then the facility computer 30 renews modeling using monitoring data detected in a preceding unit process as reference data (S80). The modeling renewal may be performed whenever a unit process is changed. Thus, the modeling may be renewed on a cycle with respect to not only a substrate but also a plurality of substrates. The facility computer 30 performs a unit process again using a renewed modeling (S40). The corresponding unit process may be managed by T² statistics using monitoring data in a preceding unit process as reference data. The monitoring data of a preceding unit process may be compared with monitoring data in a modeling of the corresponding unit process. The facility computer 30 can monitor the semiconductor manufacturing facilities 10.

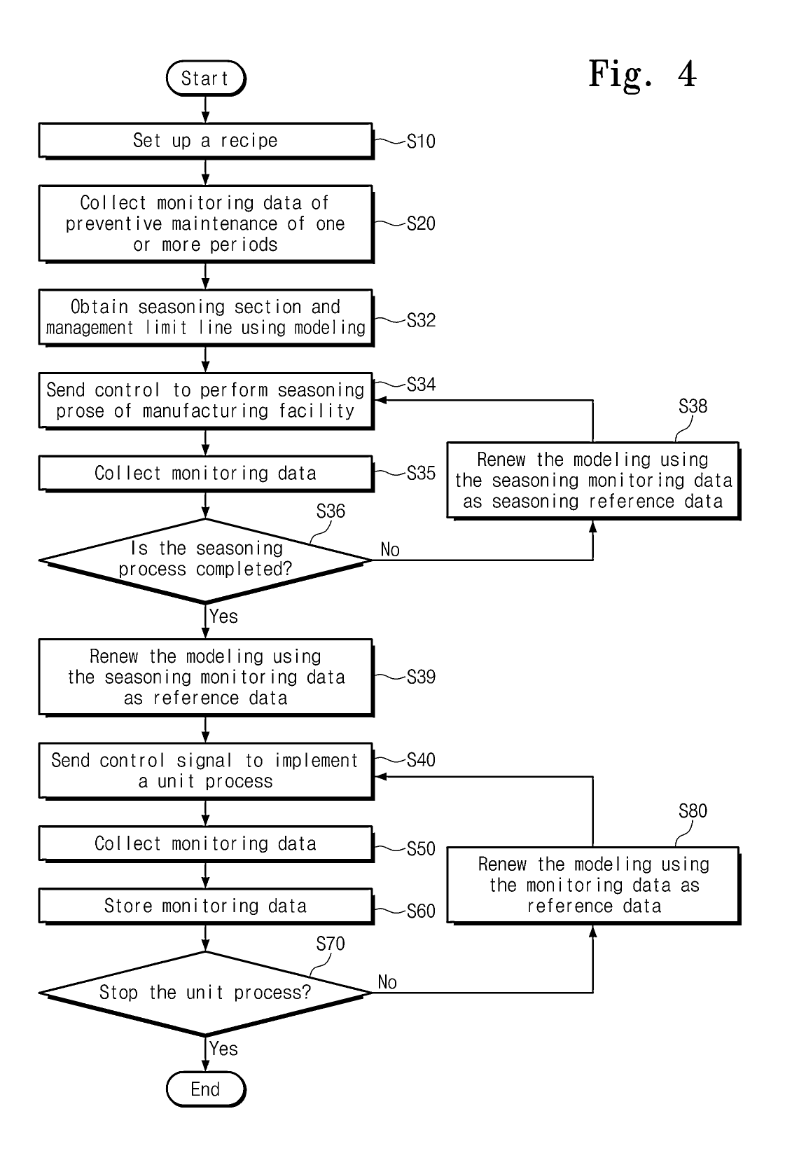

Thus, the method of maintaining a semiconductor manufacturing line in accordance to the above described example embodiment may include a statistical control method or a statistical management method. An alternative example embodiment for maintaining a semiconductor manufacturing line is described below with reference to FIG. 4.

FIG. 4 is a time flow chart illustrating a method for maintaining a semiconductor manufacturing line, according to an example embodiment.

Accordingly, the facility computer 30 obtains a seasoning section line by a modeling prior to controlling the manufacturing facility 10 in performing/implementing a unit process. A seasoning process is a preparation process of coating a specific amount of polymer on an inner wall of the chamber before producing/manufacturing semiconductor devices. Such modeling may include renewing the modeling if a seasoning process is not finished after performing the seasoning process. The seasoning process may be performed until a T² value below the seasoning section line is obtained. The seasoning process may be performed in the manufacturing facility 10 which is any one of, but not limited to, an etching facility, a deposition facility, a photo facility, an ashing facility and an ion implantation facility.

Referring to FIGS. 1 and 4, the facility computer 30 sets up a recipe of the manufacturing facility 10 for a corresponding unit process (S10). Thereafter, the facility computer 30 collects reference data (S20), as also described above with reference to S20 of FIG. 2.

Next, the facility computer 30 obtains a modeling that statistically manages the manufacturing facility 10 and a health index of the modeling are drawn on the basis of the reference data (S32). Herein, the health index may include a seasoning section line of the manufacturing facility 10 and a T² value of management limit line.

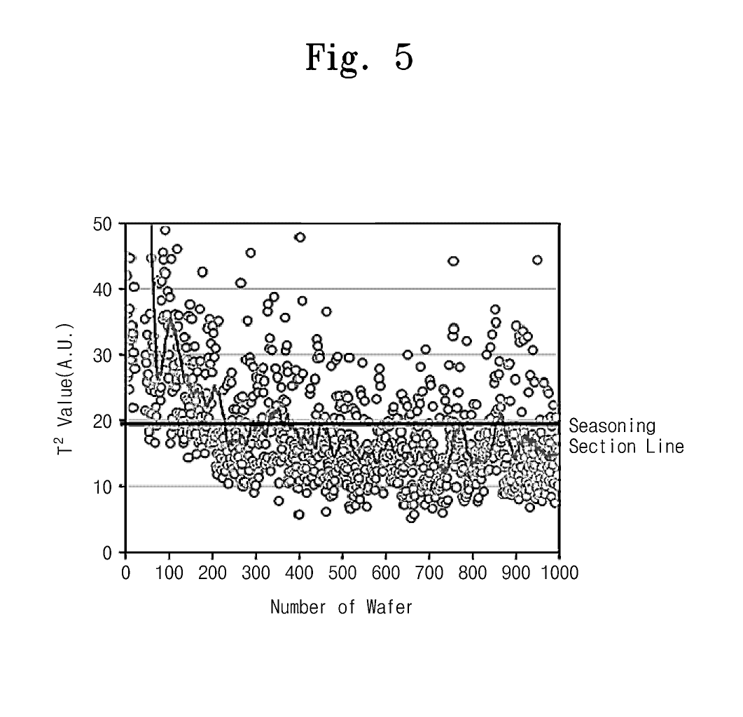

FIG. 5 is a graph illustrating a seasoning section line of T² statistics, according to an example embodiment. The seasoning section line has a T² value of about 20. A horizontal axis represents the number of wafers which finished a corresponding unit process. A vertical axis represents a T² value and has no unit. A T² value of the seasoning section line and a T² value of the management limit line are statistical numerical value for a process monitoring of the manufacturing facility 10.

Referring back to FIGS. 1 and 4, the facility computer 30 sends a control signal to the manufacturing facility 10 to perform a seasoning process (S34). The facility computer 30 may collect monitoring data associated with a state of the manufacturing facility 10 in real time using a modeling as determined at S32 (S35). Such modeling may be calculated from seasoning monitoring data being detected through the detector 20 in the manufacturing facility 10 which is in operation. As reflected by the mathematical formula (1), the seasoning monitoring data may be managed as T² statistics according to a generalized distance of the seasoning monitoring data from the seasoning reference data. The seasoning reference data may be seasoning monitoring data of a preceding process just before a corresponding unit process. The seasoning reference data may be an external input provided after a preventive maintenance of the manufacturing facility 10 and prior to the first unit process to be implemented by the manufacturing facility 10. In one example embodiment, the seasoning reference data may be monitoring data just before a preventive maintenance. In one example embodiment, the facility computer 30 collects seasoning monitoring data to store the seasoning monitoring data in the data base 40.

The facility computer 30 determines whether the seasoning process of manufacturing facility 10 is completed (S36). The facility computer 30 can monitor a seasoning process of the manufacturing facility 10 based on a T² value of the seasoning section line. Like FIG. 5, when a T² value is below the seasoning section line, the seasoning process of the manufacturing facility 10 may be completed. Accordingly, the facility computer 30 may determine a completion time of the seasoning process of the manufacturing facility 10.

If the seasoning process is not completed, the facility computer 30 renews the modeling using the seasoning monitoring data as the seasoning reference data (S38). The seasoning reference data may be compared with the seasoning monitoring data in a modeling of a subsequent seasoning process. The facility computer 30 performs a seasoning process using the renewed modeling again (S34).

If the seasoning process is completed, the facility computer 30 renews the modeling using the seasoning monitoring data as the reference data (S39). In one example embodiment, the reference data may be an external input.

The facility computer 30 may then send a control signal to the manufacturing facility 10 to perform/implement a unit process corresponding to the recipe determined at S10, using the renewed modeling (S40). The unit process may include processes for one substrate, one lot, a plurality of substrates or a plurality of lots. The modeling can be calculated from monitoring data being detected through the detector 20 in the manufacturing facility 10 which is in operation.

The facility computer 30 may collect monitoring data corresponding to the unit process being performed/implemented by the manufacturing facility (S50). The monitoring data may be T² statistics according to a generalized distance between the monitoring data and the reference data. The facility computer 30 may store the collected monitoring data in the database 40 (S60). The facility computer 30 can monitor whether a T² value of T² statistics exceeds the management limit line. If a T² value of T² statistics exceeds the management limit line, the facility computer 30 may output an interlock control signal to the manufacturing facility 10, directing the manufacturing facility 10 to terminate the manufacturing of the semiconductor devices.

As described above, the facility computer 30 determines whether a unit process is to be stopped (S70). If the unit process is not completed, the facility computer 30 renews a modeling (S80), and then may perform the unit process at S40 again.

The method of maintaining a semiconductor manufacturing line as described with respect to FIG. 4, may statistically monitor a seasoning process and a unit process of the manufacturing facility 10.

In one example embodiment, a facility computer collects reference data through a reference process being performed according to a reference recipe of a manufacturing facility and can statistically model the reference data. The facility computer may draw a health index from a modeling. The health index may include a seasoning section line and a T² value of management limit line. The facility computer may monitor a unit process using the modeling. A data base may store measuring data obtained from the unit process. The facility computer may renew a modeling in a subsequent process by using monitoring data of a preceding unit process as reference data. Thus, a method of managing a semiconductor manufacturing line may include a statistical control method and a statistical management method of the unit process.

The facility computer may monitor a seasoning process using a modeling. When a T² value is below the seasoning section line, the seasoning process can be completed. Thus, the facility computer may understand the stabilization time of the manufacturing facility.

Variations of the example embodiments are not to be regarded as a departure from the spirit and scope of the example embodiments, and all such variations as would be apparent to one skilled in the art are intended to be included within the scope of this disclosure.

1. A method of maintaining a semiconductor manufacturing line comprising:
setting up a recipe for controlling an implementation of a unit process based on which at least one semiconductor device is manufactured by a manufacturing facility;
collecting reference data of the manufacturing facility being controlled according to the recipe;
obtaining a statistical model of the reference data and a health index of the statistical model, the health index being a limit beyond which an output of the semiconductor manufacturing line decreases;
controlling the implementation of the unit process;
obtaining monitoring data during the implementation of the unit process using the statistical model; and
renewing the statistical model based on the monitoring data.

2. The method of claim 1, wherein the statistical model is based on T² statistics.

3. The method of claim 2, wherein the T² statistics are based on the monitoring data and a T² value is associated with a generalized distance between the reference data and the monitoring data.

4. The method of claim 3, wherein the health index is a management limit line of the T² value.

5. The method of claim 4, wherein the health index is a seasoning section line of the manufacturing facility.

6. The method of claim 5, further comprising:
performing a seasoning process of the manufacturing facility, the seasoning process including coating a chamber of the manufacturing facility prior to the manufacturing facility initiating production of the at least one semiconductor device;
obtaining seasoning monitoring data of the seasoning process using the statistical model and a seasoning section line;
judging whether the seasoning process of the manufacturing facility is completed based on the seasoning section line;
renewing the statistical model using the seasoning monitoring data as a seasoning reference data if the seasoning process is not completed; and
repeating the seasoning process.

7. The method of claim 6, wherein when the T² value is below the seasoning section line, the seasoning process is completed.

8. The method of claim 6, further comprising:
renewing the statistical model based on the seasoning monitoring data when the seasoning process is completed.

9. The method of claim 4, further comprising:
generating an interlock control signal when the T² value deviates from the management limit line; and
communicating the interlock control signal to the manufacturing facility.

10. The method of claim 3, wherein the management limit line is calculated from F distribution.

11. A method of maintaining a semiconductor manufacturing comprising:
setting up a recipe for controlling an implementation of a unit process based on which at least one semiconductor device is manufactured by a manufacturing facility;
collecting reference data of the manufacturing facility being controlled according to the recipe;
obtaining a statistical model for the reference data and a health index of the statistical model;
performing a seasoning process of the manufacturing facility;
obtaining first monitoring data of the seasoning process using the statistical model;
judging whether the seasoning process of the manufacturing facility is completed based on the health index;
renewing the statistical model using the first monitoring data as the reference data when the seasoning process is completed;
controlling the implementation of the unit process;
obtaining second monitoring data during the implementation of the unit process using the renewed statistical model; and
further renewing the renewed statistical model using the second monitoring data as the reference data.

12. The method of claim 11, wherein upon judging the seasoning process of the manufacturing facility is not complete, the renewing comprises:
renewing the statistical model using the seasoning monitoring data as the reference data.

13. The method of claim 11, wherein the health index is at least one of a seasoning section line value and a management limit line value being calculated based on the statistical model.

14. The method of claim 13, wherein when a statistics value of the statistical model is below the seasoning section line value, the seasoning process is completed.

15. The method of claim 13, further comprising:
generating an interlock control signal when a statistics value of the statistical model exceeds the management limit line value; and
communicating the interlock control signal to the manufacturing facility.

16. A method of maintaining a semiconductor production line, comprising:
controlling at least one manufacturing facility based on a unit process, the manufacturing facility manufacturing a plurality of semiconductor devices, the unit process being used in manufacturing the plurality of semiconductor devices;
determining a statistical model and an associated first threshold based on the controlling;
monitoring the at least one manufacturing facility as the at least one manufacturing facility manufactures the plurality of semiconductor devices according to the unit process; and
determining whether to terminate the unit process based on at least the monitoring, the statistical model and the associated first threshold.

17. The method of claim 16, wherein the controlling comprises:
selecting a recipe for the unit process; and
obtaining reference data associated with the at least one manufacturing facility of the semiconductor production line.

18. The method of claim 17, wherein the unit process is at least one of an etching process, a deposition process, a photo process, an ashing process and an ion implantation process, and
the reference data is at least one of monitoring data associated with a preceding unit process and data associated with a preventive maintenance period prior to manufacturing of the plurality of semiconductor devices according to the unit process.

19. The method of claim 16, further comprising:
performing a seasoning process of the at least one manufacturing facility prior to the at least one manufacturing facility manufacturing the plurality of semiconductor devices according to the unit process, the seasoning process including coating a chamber of the at least one manufacturing facility prior to the manufacturing facility initiating the manufacturing.

20. The method of claim 19, wherein the performing the seasoning process comprises:
obtaining seasoning monitoring data of the seasoning process using the statistical model and an associated second threshold;
determining whether the seasoning process of the manufacturing facility is completed based on the associated second threshold; and
renewing the statistical model using the seasoning monitoring data as a seasoning reference data if the seasoning process is not completed.

21. (canceled)
